(19) United States
(12) Patent Application Publication
(10) Pub. No.: US 2026/0088430 A1
(43) Pub. Date: Mar. 26, 2026

(54) BATTERY COVER ASSEMBLY

(71) Applicant: Project-X18, Inc., Overland Park, KS (US)

(72) Inventors: Brock Templeman, Overland Park, KS (US); Jon Templeman, Overland Park, KS (US)

(21) Appl. No.: 19/081,475

(22) Filed: Mar. 17, 2025

Related U.S. Application Data
(60) Provisional application No. 63/697,800, filed on Sep. 23, 2024.

(51) Int. Cl. H01M 50/271; H01M 50/249; H01M 50/264

(52) U.S. Cl. CPC H01M 50/271; H01M 50/249; H01M 50/264

(57) ABSTRACT

A battery cover assembly for protecting and locking a vehicle battery. The battery cover assembly prevents theft of the battery, creates no fitment problems with existing OEM battery compartments, is relatively inexpensive to manufacture, reduces the risk of short-circuiting; covers unattractive battery markings on the battery, protects the battery from harsh chemicals; and assists with the attenuation of vibrations and shocks that could harm the battery.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/697800; titled “LOCKING BATTERY COVER PLATE”; and filed Sep. 23, 2024. The Provisional Application is hereby incorporated by reference, in its entirety, into the current patent application.

### BACKGROUND OF THE INVENTION

Cars, boats, motorcycles, and other vehicles typically include one or more batteries for storing and providing electrical power to the vehicles. Because of their high value, batteries are susceptible to theft, especially when they are installed in easily accessible areas in their vehicles. For example, batteries in Jeep Wranglers and other vehicles with external hood latches are often stolen, as are batteries in boats with open storage compartments, batteries on travel-trailer tongues, and batteries in other unsecured areas. After-market battery locking brackets and other battery security mechanisms have been developed to address this problem, but they often don't fit in OEM battery compartments, are expensive and unattractive, and don't provide functions other than battery theft prevention.

Another problem with vehicle batteries is the risk of short-circuiting, which occurs when a conductive material simultaneously touches a battery's positive and negative terminals, causing sparks, over-heating, fire, battery damage, and sometimes personal injury and even death. It is therefore important to prevent a battery's positive and negative terminals from simultaneously coming into contact with conductive materials. Removable terminal boots, temporary terminal covers, and plastic battery boxes attempt to serve this purpose, but terminal boots and terminal covers often shift or become detached during vehicle operation, and plastic battery boxes often don't fit in OEM battery compartments and are unattractive, unstable, and have poor venting of gas fumes and other combustible materials that may migrate into the boxes.

Another problem with vehicle batteries is that they typically have warnings, marketing messages, and battery technical information on their lids that are useful when installing or un-installing them but that are unnecessary at other times and detract from the aesthetics of their vehicles.

Yet another problem with vehicle batteries is that they can fail or prematurely degrade in performance due to excessive vibrations and/or shocks generated or transmitted by the vehicles and/or the vehicles'operating environments. This is especially true for batteries used in trucks, off-road vehicles, boats, personal watercraft, all-terrain vehicles, and other vehicles that operate in rough water or on uneven terrain.

Vehicle batteries are also subjected to harsh operating environments including high and low temperature ranges; a wide variety of under-the-hood chemicals such as gasoline, oil, power steering fluid, transmission fluid, brake fluid, windshield wiper fluid, water, etc. ; and multi-directional operating forces that put varying levels of stress and strain on the structure of the batteries.

### SUMMARY OF THE INVENTION

The present invention solves the above-described problems and related problems by providing a protective battery cover for protecting and locking a vehicle battery. The battery cover assembly more effectively prevents theft of its battery, creates no fitment problems with existing OEM battery compartments, and is relatively inexpensive to manufacture. Embodiments of the battery cover assembly also simultaneously provide other benefits such as reducing the risk of short-circuiting; covering up unattractive battery markings and warnings on the battery without making them inaccessible during battery installation or removal; protecting the battery from harsh chemicals; and assisting with the attenuation of vibrations and shocks that could harm the battery. Embodiments of the battery cover assembly can be easily configured to fit any type and size of battery, including lithium batteries, absorbent glass mat (AGM) batteries, flooded lead-acid batteries, A/B type batteries, and solid-state batteries and for all applications-from large submarine batteries down to the smallest lawn and garden batteries.

One embodiment of the battery cover assembly is configured for use with a vehicle battery having a shell with an upper surface. A plurality of internally threaded sockets or other electrically non-conductive fastening elements are formed in the upper surface of the shell. Positive and negative terminals extend upwardly from the upper surface for connecting with vehicle battery cables.

An embodiment of the battery cover assembly broadly comprises a protective cover and a plurality of fasteners. The protective cover is formed of electrically non-conducting materials and is sized and configured to cover the upper surface of the battery shell and the positive and negative terminals of the battery. A number of through holes are formed in the protective cover that align with the fastening elements in the upper surface of the shell.

The fasteners are configured to be placed through the through holes in the protective cover and into the sockets or other fastening elements in the battery shell to lock the protective cover onto the battery and to prevent the battery cables from being removed from the positive and negative terminals of the battery. In some embodiments, the fasteners can only be removed with a unique key or other anti-theft unlocking element. In some embodiments, the fasteners are made of electrically non-conductive materials.

In addition to preventing theft of the battery, the battery cover assembly covers the battery terminals to significantly reduce short circuit risks; protects the battery terminals and other parts of the battery from harsh chemicals; covers unattractive battery markings and warnings on the battery without making them inaccessible during battery installation or removal; and provides a surface on which to print or otherwise apply branding information, battery size information, and other useful text and graphics.

In some embodiments, the battery cover assembly is part of a shock and vibration barrier that attenuates vibrations and shocks that could harm the battery. The shock and vibration barrier may include, in addition to the battery cover assembly, a shock and vibration absorbing pad that attaches to a bottom surface of the battery; a base plate for receiving and supporting the shock and vibration absorbing pad and the bottom surface of the battery; and a pair of clamps for securing the shock and vibration absorbing pad to the base plate.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the present invention are described in detail below with reference to the attached drawing figures, wherein:

FIG. 1 is a partially exploded perspective view of a battery cover assembly constructed in accordance with embodiments of the present invention and shown attached to a battery.

FIG. 2 is a perspective view of the battery cover assembly attached to the battery.

FIG. 3 is a top view of the battery with the battery cover assembly removed.

FIG. 4 is a top view of the battery cover assembly attached to the battery.

FIG. 5 is a perspective view of a key that may be used with the battery cover assembly.

The drawing figures do not limit the present invention to the specific embodiments disclosed and described herein. The drawings are not necessarily to scale, emphasis instead being placed upon clearly illustrating the principles of the invention.

### DESCRIPTION OF EMBODIMENTS OF INVENTION

A battery cover assembly 10 constructed in accordance with embodiments of the present invention is shown in the attached drawing figures. As described in more detail below, the battery cover assembly 10 protects and prevents theft of a battery 12 to which it is attached. The battery cover assembly also creates no fitment problems with existing OEM battery compartments, is relatively inexpensive to manufacture, and simultaneously provides other benefits such as reducing the risk of battery short-circuiting; covering up unattractive battery markings and warnings without making them inaccessible during battery installation or removal; and assisting with the attenuation of vibrations and shocks that could harm the battery and protecting the battery from harsh chemicals.

The battery cover assembly 10 may be used with any batteries, including lithium batteries, absorbent glass mat batteries, flooded lead-acid batteries, A/B type batteries, solid-state batteries, or any other battery types designed for use in vehicles and other devices. The battery 12 to which the battery cover assembly 10 is attached may be designed to start internal combustion engines or may power the electric motors of electrically powered vehicles.

An exemplary battery 12 to which the battery cover assembly 10 may be attached is shown in the drawing figures and includes a partially hollow shell 14 that encloses a number of conventional battery plates. The shell has an upper surface 16 with two recessed areas 18 through which positive and negative terminals 20, 22 extend such that the tops of the terminals are about level with the shell's upper surface 16. The terminals 20, 22 are electrically connected to the internal battery components and are configured to connect with battery cables in a vehicle. The battery shell 14 may be formed of any corrosion-resistant materials and conforms to BCISM Battery Group Size requirements and/or other battery group size specifications. The battery shell also includes a plurality of internally-threaded sockets or other fastening elements 24 in its upper surface 16, the purposes of which are described below. The fastening elements may be female-type sockets as illustrated or male-type posts. The fastening elements are not electrically connected to the battery terminals. In one embodiment, the sockets or other fastening elements 24 are electrically non-conductive, but in some embodiments they are formed of conductive materials.

More details of the battery cover assembly 10 will now be described. The battery cover assembly is made of durable, recyclable materials and can be easily configured to fit any type and size of battery. An embodiment of the battery cover assembly broadly comprises a protective cover 26, a plurality of fasteners 28 and/or other locking elements, and an unlocking element 30.

The protective cover 26 is formed of plastic, rubber, fibrous materials, or other electrically non-conducting materials and is sized to cover the upper surface of the battery 12 and the positive and negative terminals 20, 22 of the battery. In one embodiment, the protective cover 26 is approximately 6-12″ wide; 8-16″ long; and 0.1″ thick. In another embodiment, the protective cover is greater than 0.1″ thick. In yet another embodiment, the protective cover is between 0.1″-0.5″ thick.

The protective cover 26 is attached to the upper surface 16 of the battery with the anti-theft fasteners 28 or other anti-theft locking elements. The protective cover 26 locks the battery cables onto the terminals to further prevent someone from attempting to steal the battery. While in some embodiments the protective cover must be removed to attach the battery cables to the vehicle, the battery and shock and vibration barrier may be fully assembled with the protective cover attached when presented for sale to consumers and installers. An installer may then remove the protective cover before the battery is installed in a vehicle.

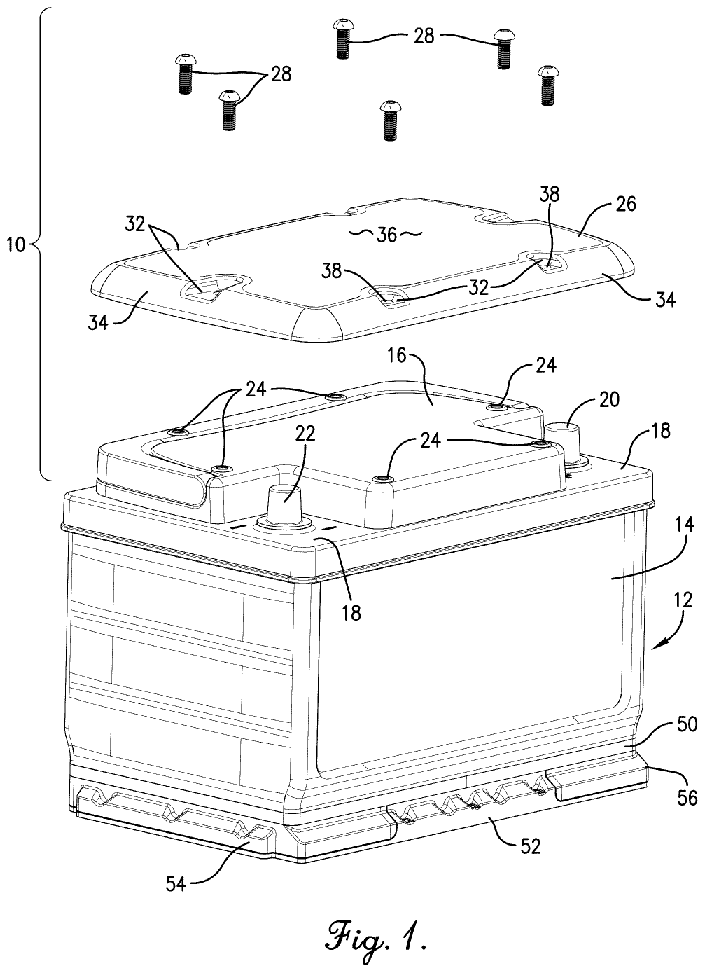

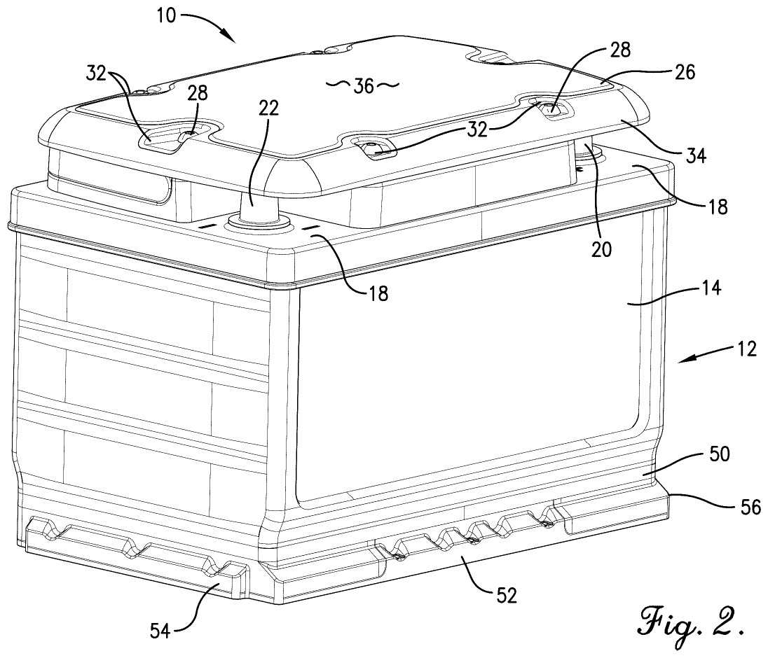

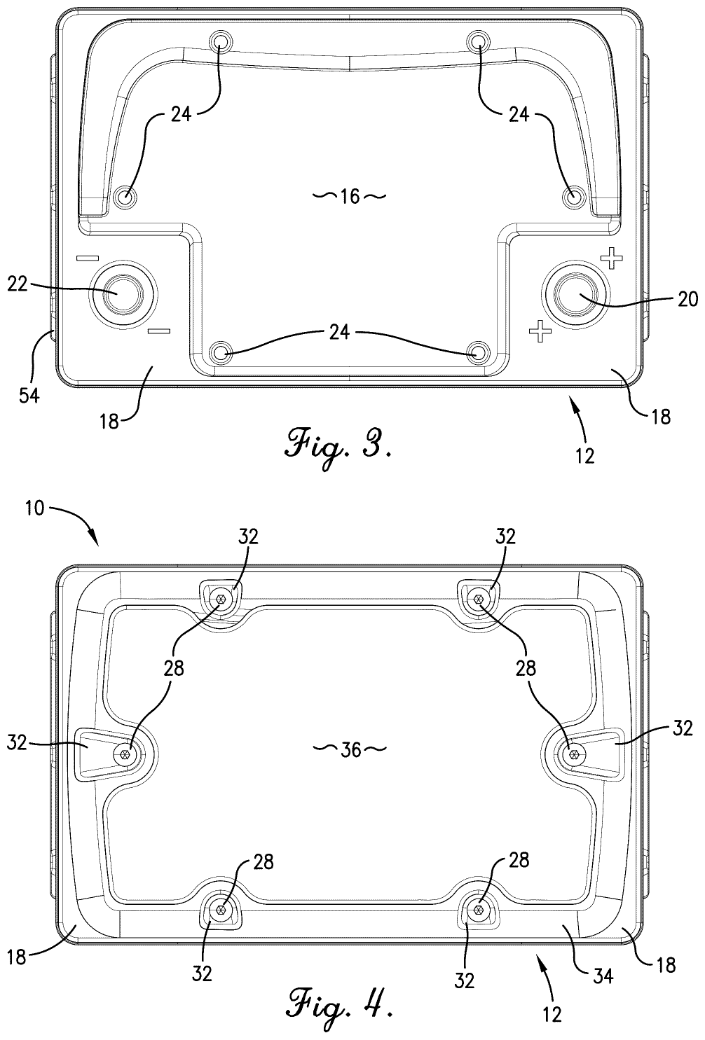

As best shown in FIG. 1, the protective cover 26 has a number of recessed areas 32, the purpose of which is explained below. The protective cover also has beveled edges 34 and a relatively planar middle portion 36 on which logos, graphics, branding, and/or other text or designs may be printed, engraved, etc.

In accordance with an important aspect of the invention, a through hole 38 is formed through each of the recessed areas 32 and through the upper and lower faces of the protective cover. The through holes 38 align with the internally threaded sockets or other fastening elements 24 in the upper surface of the battery shell when the protective cover is placed over the battery. In one embodiment, the through holes 38 are internally-threaded, and in another embodiment, they are not threaded.

The fasteners 28 are configured to be placed through the through holes 38 in the protective cover 26 and into the sockets or other fastening elements 24 in the upper surface of the battery to lock the protective cover 26 onto the battery 12. When locked on the battery, the protective cover prevents the battery cables from being removed from the positive and negative terminals of the battery and thus prevents theft or other unauthorized removal of the battery from the vehicle. In one embodiment, the fasteners are externally threaded bolts that are threaded into the internally-threaded holes 38 in the protective cover and the internally-threaded sockets 24 in the upper surface of the shell. The bolts have heads with a unique socket pattern, the purpose of which is described below. In some embodiments, the bolts are formed of electrically non-conductive materials. The fasteners 28 may also be screws, clamps, ties, or any other mechanism that can affix the protective cover 26 on the top of the battery 12. When the Fastening element 24 in the battery shell are male-type posts, the Fasteners may be nuts or other devices that engage the posts.

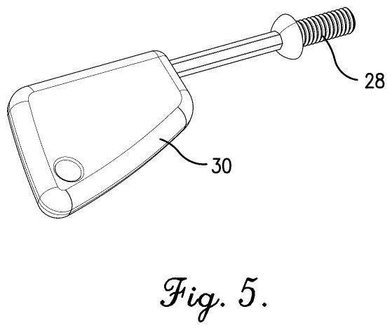

As best shown in FIG. 5, the battery cover assembly 10 may further comprise or be accompanied with a key or other anti-theft unlocking element 30. The key has a shaft with a head pattern that matches the socket pattern in the heads of the fasteners 28 or other locking elements. The key or other anti-theft unlocking element 30 is required to insert and remove the fasteners 28 or other locking elements to provide additional theft protection. In another embodiment, the anti-theft unlocking element may be keys, sockets, wrenches, drivers, pins, numerical combinations, electrical signals, fingerprint recognition devices, facial recognition devices, password devices, push-buttons, or magnets.

Because the battery cover assembly 10 covers the battery terminals 20, 22, it prevents conductive elements from simultaneously contacting the battery terminals and causing a short circuit. The battery cover assembly 10 also protects the battery 12 from harsh chemicals, covers unattractive battery markings and warnings on the battery without making them inaccessible during battery installation or removal, and provides a surface on which to print or otherwise apply branding information, battery size information, and other useful text and graphics.

The battery cover assembly 10 described above and other embodiments of the invention may be incorporated in shock and vibration barriers that attenuate vibrations and shocks that could harm batteries. In addition to the battery cover assembly, a shock and vibration barrier constructed in accordance with embodiments of the invention may include a shock and vibration absorbing pad 50 that attaches to a bottom surface of the battery; a base plate 52 for receiving and supporting the shock and vibration absorbing pad and the bottom surface of the battery; and a pair of clamps 54, 56 for securing the shock and vibration absorbing pad to the base plate.

### Additional Considerations

The detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The detailed description is, therefore, not to be taken in a limiting sense. The scope of the current invention is defined only by the appended claims, along with the full scope of equivalents to which such claims are entitled.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for”or “step for”language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A battery cover assembly for protecting and locking a vehicle battery, the vehicle battery having a shell with an upper surface, at least one fastening element in the shell, and positive and negative terminals extending from the shell that connect with battery cables in a vehicle, the battery cover assembly comprising:
a single piece, monolithic protective cover formed of electrically non-conducting materials that covers the upper surface of the battery shell and both the positive and negative terminals of the battery;
at least one through hole in the protective cover that aligns with the at least one fastening element in the shell of the battery; and
at least one fastener that is placed through the at least one through hole in the protective cover and into the at least one fastening element in the shell to lock the protective cover onto the battery such that tops of the positive and negative terminals cannot be accessed without first removing the protective cover.

2. The battery cover assembly of claim 1, further comprising a key for inserting the at least one fastener in the at least one fastening element in the shell.

3. The battery cover assembly of claim 1, wherein the protective cover has a wall thickness of 0.05″ or greater.

4. The battery cover assembly of claim 1, wherein the protective cover has a wall thickness of 0.1″ or greater.

5. The battery cover assembly of claim 1, wherein the protective cover has beveled edges and a planar surface on which identifying markings may be placed.

6. The battery cover assembly of claim 5, wherein the at least one through hole in the protective cover is an internally-threaded hole.

7. The battery cover assembly of claim 6, wherein the at least one fastener is an externally threaded bolt that is threaded into the internally-threaded hole in the protective cover and the at least one fastening element in the shell.

8. The battery cover assembly of claim 1, the protective cover having at least one recess, wherein the through hole is formed in the at least one recess.

9. A battery assembly with integrated anti-theft features, the battery assembly comprising:
a battery comprising:
a shell with an upper surface and two recessed areas;
battery terminals extending through the recessed areas of the shell, the battery terminals having tops that are level with the upper surface of the shell;
a plurality of fastening elements formed in the shell that are not electrically connected to the battery terminals;
a single piece, monolithic protective cover formed of electrically non-conductive materials that removably covers the battery terminals, the protective cover comprising an upper surface and a lower surface, the upper surface having a planar middle portion, the lower surface rests on the upper surface of the shell and the tops of the battery terminals and above the recessed areas of the shell such that the battery terminals are below and completely covered by the lower surface of the protective cover, the protective cover further comprising a circumscribing beveled edge, recessed areas that span the beveled edge and the planar middle portion, and a plurality of through holes formed in the recessed areas that align with the fastening elements in the shell; and
a plurality of fasteners that are placed through the through holes in the protective cover and the fastening elements in the shell to lock the protective cover onto the shell.

10. The battery assembly of claim 9, wherein the fastening elements formed in the shell are formed in the upper surface of the shell.

11. The battery assembly of claim 9, further comprising a key for inserting the fasteners in the fastening elements in the shell.

12. The battery assembly of claim 9, wherein the fastening elements in the shell are internally-threaded, wherein the fasteners are externally threaded bolts that are inserted through the through holes in the protective cover and into the internally-threaded fastening elements in the shell.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A battery assembly with integrated anti-theft features, the battery assembly comprising:
a battery comprising:
a shell with a bottom surface, an upper surface, and two recessed areas adjacent the upper surface;
battery terminals extending from through the recessed areas of the shell, the battery terminals having tops that are level with the upper surface of the shell;
a plurality of fastening elements formed in the shell that are not electrically connected to the battery terminals;
a single piece, monolithic protective cover formed entirely of electrically non-conductive materials that removably covers the battery terminals, the protective cover comprising an upper surface and a lower surface, the upper surface having a planar middle portion, the lower surface rests on the upper surface of the shell and the tops of the battery terminals and above the recessed areas of the shell such that the battery terminals are below and completely covered by the lower surface of the protective cover, the protective cover further comprising a circumscribing beveled edge, recessed areas, and a plurality of through holes formed in the recessed areas that align with the fastening elements in the shell;
a plurality of fasteners that are placed through the through holes in the protective cover and the fastening elements in the shell to lock the protective cover onto the shell; and
a shock and vibration absorbing pad attached to the bottom surface of the shell.

40. The battery assembly of claim 39, wherein the fastening elements formed in the shell are formed in the upper surface of the shell.

41. The battery assembly of claim 39, further comprising a key for inserting the fasteners in the fastening elements in the shell.

42. The battery assembly of claim 39, wherein the fastening elements in the shell are internally-threaded, wherein the fasteners are externally threaded bolts that are inserted through the through holes in the protective cover and into the internally-threaded fastening elements in the shell.

43. The battery assembly of claim 39, further comprising a base plate for receiving the shock and vibration absorbing pad and the bottom surface of the shell of the battery.

44. The battery assembly of claim 43, further comprising a pair of clamps for securing the shock and vibration absorbing pad to the base plate.

45. A battery assembly with integrated anti-theft features, the battery assembly comprising:
a battery comprising:
a shell with a bottom surface, an upper surface, and two recessed areas adjacent the upper surface;
battery terminals extending from through the recessed areas of the shell, the battery terminals having tops that are level with the upper surface of the shell;
a plurality of fastening elements formed in the shell that are not electrically connected to the battery terminals;
a protective cover formed entirely of electrically non-conductive materials that removably covers the battery terminals, the protective cover comprising an upper surface and a lower surface, the upper surface having a planar middle portion, the lower surface rests on the upper surface of the shell and the tops of the battery terminals and above the recessed areas of the shell such that the battery terminals are below and completely covered by the lower surface of the protective cover, the protective cover further comprising a circumscribing beveled edge, recessed areas, and a plurality of through holes formed in the recessed areas that align with the fastening elements in the shell;
a plurality of fasteners that are placed through the through holes in the protective cover and the fastening elements in the shell to lock the protective cover onto the shell;
a shock and vibration absorbing pad attached to the bottom surface of the shell;
a base plate for receiving the shock and vibration absorbing pad and the bottom surface of the shell ; and
a pair of clamps for securing the shock and vibration absorbing pad to the base plate.

46. The battery assembly of claim 45, wherein the fastening elements formed in the shell are formed in the upper surface of the shell.

47. The battery assembly of claim 45, further comprising a key for inserting the fasteners in the fastening elements in the shell.

48. The battery assembly of claim 45, wherein the fastening elements in the shell are internally-threaded, wherein the fasteners are externally threaded bolts that are inserted through the through holes in the protective cover and into the internally-threaded fastening elements in the shell.
